(19) United States
(12) Patent Application Publication
(10) Pub. No.: US 2017/0037896 A1
(43) Pub. Date: Feb. 9, 2017

(54) NON-SPLIT BEARING DESIGN FOR A TUBULAR BAT SHAPE WITH LONGITUDINAL KEY, FOR USE WITH THE PICK-UP REEL OF A HARVESTER

(71) Applicant: HCC, INC., Mendota, IL (US)

(72) Inventor: Edward Patrick Jasper, Mendota, IL (US)

(21) Appl. No.: 15/225,363

(22) Filed: Aug. 1, 2016

Related U.S. Application Data
(60) Provisional application No. 62/201,275, filed on Aug. 5, 2015.

(51) Int. Cl. F16C 19/26; A01D 57/12

(52) U.S. Cl. CPC F16C 19/26; A01D 57/12

(57) ABSTRACT

A non-split bearing design for use with a harvester pick-up reel. In one specific embodiment, the outer member directly engages the inner member. In another embodiment, the bearing is provided as being an interchangeable roller bearing, and in that case there is preferably an intermediate member which is disposed between the outer member and the inner member. Regardless, providing that the bearing is non-split provides that the design is simplified, as well as provides that the inner bore, i.e., the bore which engages the bat tube, can be more easily controlled, thereby reducing or even eliminating service requirements.

### RELATED APPLICATION

### Priority Claim

This application claims the benefit of U.S. Provisional Application Ser. No. 62/201,275, filed Aug. 5, 2015, which is hereby incorporated herein by reference in its entirety.

### BACKGROUND

The present invention generally relates to non-split bearing designs for use with harvester pick up reels, and more specifically relates to a non-split bearing design for use with a harvester pick up reel that has bat tubes that have one or more longitudinal keys thereon.

A typical harvester includes a pick-up reel. The pick-up reel includes a plurality of bat tubes, and tines are arranged along each of the bat tubes. When the harvester operates, the pick-up reel rotates, causing the tines to engage the crop and pull the crop into the harvester.

A typical bat tube of a harvester pick-up reel has a round, tubular profile (i.e., with regard to its exterior surface, the bat tube is circular in cross-section). As such, holes need to be punched or drilled into the tube as a means to fasten tines to the tube and resist torsional loading. After holes are punched or drilled into the bat tube, the tines are secured to the bat tube using fasteners, where the fasteners engage the holes which have been punched or drilled into the bat tube. Once the holes have been punched or drilled into the bat tube, the locations of the holes are fixed. Because the locations of the holes are fixed after the bat tube has been processed, the locations of the tines are effectively pre-determined, and the space between the tines cannot be varied.

In order to reduce the space between tines, additional holes would need to be punched or drilled into the bat tube. On the other hand, in order to increase the space between tines, holes would need to be skipped when installing the tines on the bat tube. With regard to punching or drilling the holes in a bat tube, a typical bat tube is a long, single piece, thereby making the tube difficult to process.

As a result of a typical bat tube on the pick up reel comprising a single, long continuous tube, in order to allow for installation and service of the bearings, a typical bat tube requires a split, wrap-around type bearing design.

Most split bearings that are used in connection with harvester pick-up reels are made of polymer, which are therefore prone to shrinkage after molding. This can result in a non-circular bore when the bearing is installed on the bat tube. The circular bat tube can also effectively be non-circular at the bearing location, as a result of, for example, holes having been punched or drilled into the bat tube, i.e., for tine fastening. When both the bore of a bearing and the external surface of the bat tube are non-circular, bearing wear will be uneven, and wear can even be accelerated in certain conditions.

### SUMMARY

An object of an embodiment of the present invention is to provide a non-split bearing design for use with a harvester pick-up reel.

Another object of an embodiment of the present invention is to provide a non-split bearing design which can be used in connection with a harvester pick up reel that has bat tubes which have longitudinal keys thereon.

Briefly, an embodiment of the present invention provides a non-split, multiple component bearing which comprises an outer member which has a circular bore. The outer member is configured to connect to an arm of a harvester pick up reel. The non-split bearing also comprises an inner member which is configured to engage a non-circular bat tube of the harvester pick up reel. The inner member is disposed between the non-circular bat tube and the outer member, which is connected to the arm of the harvester pick up reel.

In one specific embodiment, the outer member directly engages the inner member. In another embodiment, the bearing is provided as being an interchangeable roller bearing, and in that case there is preferably an intermediate member which is disposed between the outer member and the inner member. Regardless, providing that the bearing is non-split provides that the design is simplified, as well as provides that the inner bore, i.e., the bore which engages the bat tube, can be more easily controlled.

In the embodiment where the outer member directly engages the inner member, preferably both the outer member and the inner member are formed of materials which provide not only robustness, but also even and controlled bearing wear, and reduced service requirements. Options include, but are not limited to, polymers, metals such as steel, or any other appropriate material.

In the embodiment where the bearing is provided as being an interchangeable roller bearing, and there is an intermediate member which is disposed between the outer member and the inner member, preferably there are steel bearings disposed between the inner member and the intermediate member, whereby an inner race is defined on the inner member and an outer race is defined on the intermediate member. In this embodiment, preferably the inner member, the intermediate member, and the outer member are all formed of metal, such as steel. Of course, other materials could be used.

In either embodiment, preferably the inner member includes a non-circular bore which engages the bat tube, and the surface profile of the bore effectively corresponds to the outer surface of the bat tube such that the inner member is effectively keyed to the bat tube (i.e., without the need for any fasteners to secure the inner member to the bat tube). The fact that the inner bore, i.e., the bore which engages the bat tube, is more controlled should result in much improved service cycles. In the embodiment where the bearing is provided as being an interchangeable roller bearing, and there is an intermediate member which is disposed between the outer member and the inner member, service may be even be eliminated.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a side view of a conventional harvester, which comprises a pick-up reel that utilizes bat tubes; and

FIG. 2 illustrates a portion of a pick up reel, wherein non-circular bat tube sections are implemented;

FIG. 3 is similar to FIG. 2, but shows another section of the pick up reel, illustrating the employment of a bearing design which is in accordance with a first embodiment of the present invention;

FIG. 4 provides a perspective view of a band or strap portion of tines which are shown in FIGS. 2 and 3;

FIG. 5 is similar to FIG. 4, but provides a side view of the band or strap portion of the tines;

FIGS. 6A, 6B and 6C provide cross-sectional views of different possible tubular bat shapes with which a bearing which is in accordance with an embodiment of the present invention can be used;

FIG. 7 illustrates the bearing design shown in FIG. 3, showing the bearing engaged with a bat tube section, but (for clarity) omitting an arm of the pick up reel; and

FIG. 8 illustrates a bearing design which is in accordance with a second embodiment of the present invention.

### DESCRIPTION OF ILLUSTRATED EMBODIMENTS

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

Embodiments of the present invention provide bearing designs for use with a harvester pick-up reel, which improve or even eliminate service cycles.

First, a conventional harvester which includes bat tubes will be generally described, and then a tubular bat shape (and a preferred bat tube system), which can be used in connection with a bearing design which is in accordance with an embodiment of the present invention will be described.

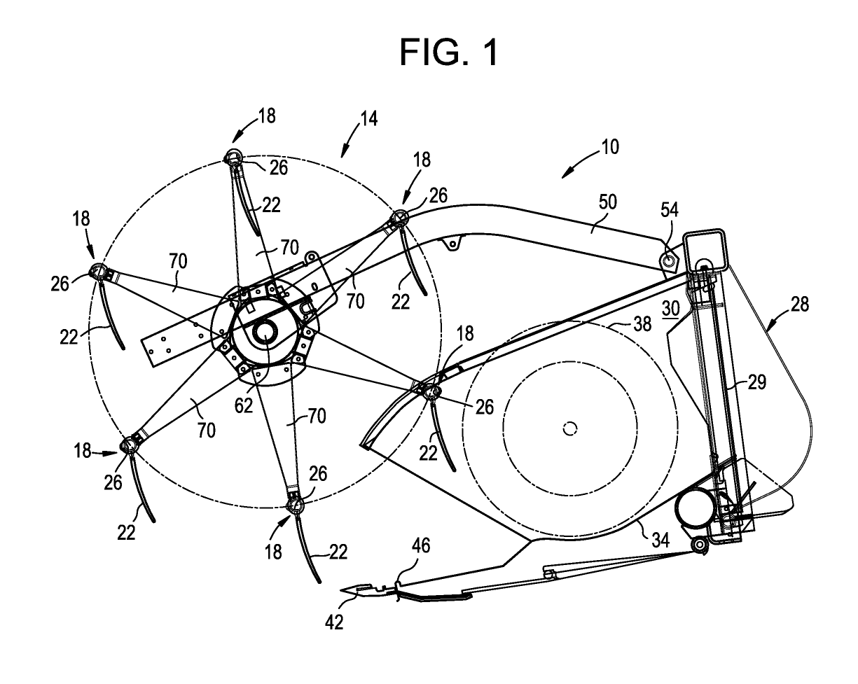

FIG. 1 is a side view of a conventional harvester 10 utilizing a pick-up reel 14. The harvester 10 shown in FIG. 1 includes a non-flip reel, i.e, a pick-up reel 14 that provides for standard tine action (i.e., that the tines 22 do not flip during harvesting), but embodiments of the present invention can be utilized with flip-type reels as well.

The harvester 10 includes the pick-up reel 14, and a harvester tine and bat tube assembly 18. The assembly 18 includes harvester tines 22 and bat tubes 26. The harvester 10 also includes a harvester platform 28 including a platform frame 29, supported for movement over ground, and side and rear wall 30. A floor 34 extends between the opposite side walls 30, and a transverse crop converging auger 38 is rotatably supported above the floor 34 and forward of the rear wall 30 (unless the harvester is provided as being a draper header type of harvester, in which case cross belts would be utilized instead of an auger). A transverse cutter bar 42 is mounted along the forward edge of the floor 34, and an upright crop dam 46 is supported between the cutter bar 42 and the floor 34.

The pick-up reel 14 generally spans the width of the platform 28, forward of the auger 38 and above the cutter bar 42. The pick-up reel 14 is connected to the platform 28 by a pair of reel support arms 50 (one shown), which support the pick-up reel 14 on the frame 29. In the construction illustrated in FIG. 1, the support arms 50 are pivotally connected to the frame 29 at pivot points 54. The support arms 50 are generally above the sidewalls 30 of the platform 28. Preferably, the support arms 50 are selectively vertically adjustable by a pair of cylinders (not shown) connected between the support arms 50 and the sidewalls 30.

A movable support structure 58 is supported at the forward end of each support arm 50. The support structures 58 are generally slidable between forward and rearward positions on the support arm 50, and their movement is controlled by a pair of cylinders (not shown). The support arms 50 and the support structures 58 are adjustably positioned to adjust the position of the pick-up reel 14 relative to the platform 28.

A tubular reel shaft or first shaft 62 is journalled by and extends between the support structures 58. The first shaft 62 is rotatable relative to the support structures 58 about its axis, and a plurality of arms 70 (six in the illustrated construction) radially extend from the shaft 62.

Bat tubes 26 are journalled in the outer ends of the arms 70. The bat tubes 26 are rotatable with the associated arms 70 and, in the illustrated construction, are rotatable relative to the associated arms 70. The bat tubes 26 span the width of the pick-up reel 14 and are generally parallel to and radially-spaced from the first shaft 62. A plurality of harvester tines 22 are connected to each bat tube 26 for movement with the bat tube 26 (in the illustrated construction, for rotation relative to the first shaft 62 and relative to the associated arms 70).

The above description regarding FIG. 1 was merely provided to explain one possible environment in which the present invention may exist, and should not be considered to be limiting in any way, as the present invention can be employed with pick-up reels and harvesters that are very different from that which is illustrated in FIG. 1.

A typical bat tube (such as part 26 in FIG. 1) has a round tubular profile (i.e., it is circular in cross-section). As such, holes need to be punched or drilled into the bat tube as a means to fasten the tines (part 22 in FIG. 1) to the bat tube and resist torsional loading. Once the holes are formed in the bat tube, the distance between the holes become fixed. Therefore, the potential locations of installed tines is effectively pre-determined depending on the locations of the holes, and the locations of the tines and the space between tines, along the length of the bat tube, cannot be varied easily.

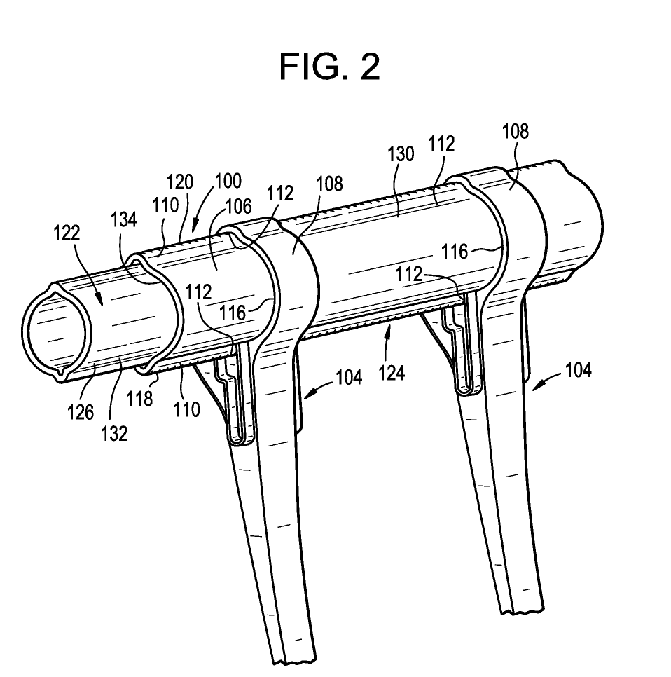

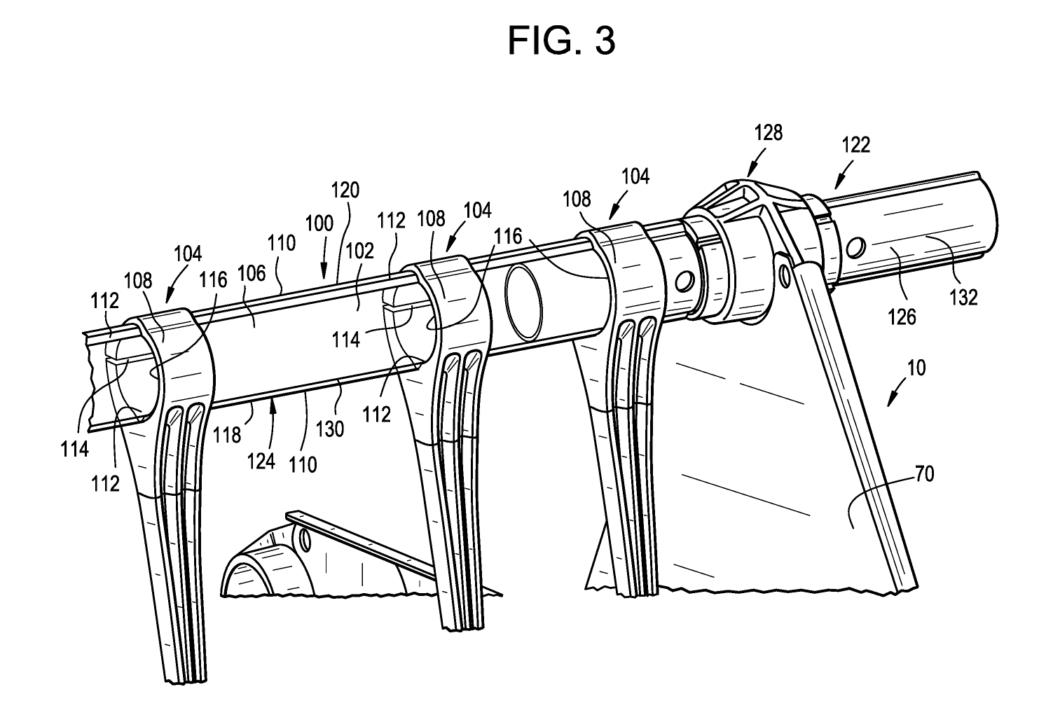

FIGS. 2 and 3 illustrate a tubular bat shape 100 which can be used in connection with a bearing design which is in accordance with an embodiment of the present invention. The tubular bat shape 100 is configured to resist torsional loads, without having to use fasteners to engage holes which have been formed previously in the bat tube 102. Additionally, the tubular bat shape 100 provides that tines 104 can be readily re-positioned along the length of the bat tube 102, thereby providing easy variance with regard to spacing between the tines 104.

While FIGS. 2 and 3 show a preferred bat tube system where the system comprises multiple profiles (i.e., a tube-in-a-tube configuration), it should be understood that a tubular bat shape which can be used in connection with embodiments of the present invention can take many other forms, and can be utilized in systems which are different from that which is shown in FIGS. 2 and 3. Regardless, FIGS. 2 and 3 will now be described in detail.

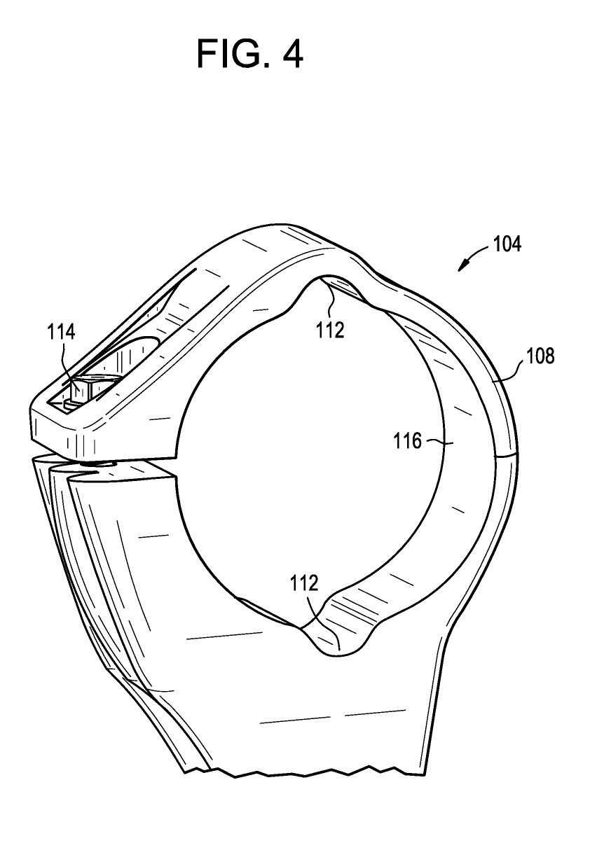

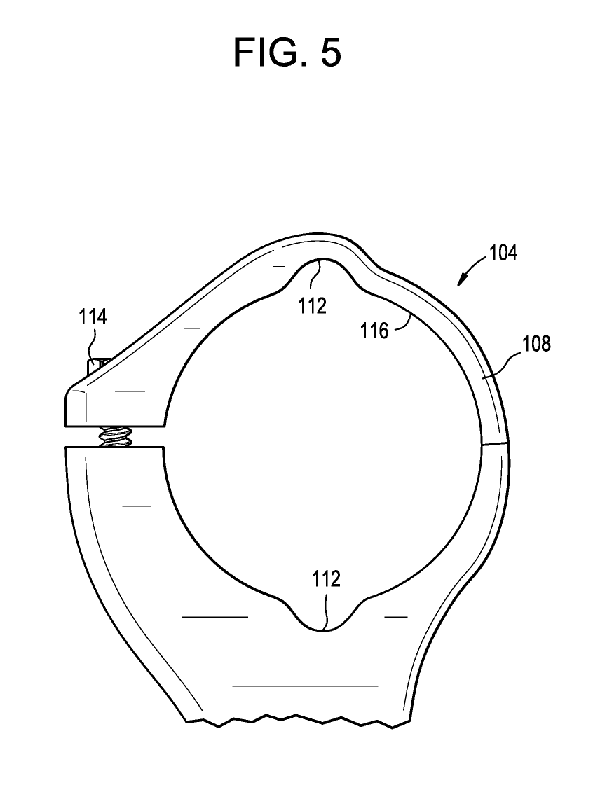

FIGS. 2 and 3 illustrate a bat tube and tine system, where the external surface 106 of the bat tube 102 with which the band or strap portions 108 of the tines 104 is provided as being non-circular in cross-section. The external surface 102 provides one or more keys 110, such as two longitudinal keys along the length of the bat tube 102, which engage one or more corresponding keyways 112 provided in the band or strap portion 108 of each of the tines 104. This key/key way engagement provides that the bat tube 102 resists torsional loads without the tines 104 having to be secured to the bat tube 102 using fasteners that engage holes formed in the bat tube 102. Additionally, the engagement provides that the tines 104 can be readily positioned at any desired location along the length of the bat tube 102, and that their positions can be easily adjusted, thereby changing the distance between the tines 104. Specifically, a fastener 114 (most easily seen in FIGS. 4 and 5) provided in the band or strap portions 108 of the tines 104 may be loosened, the tines 104 slid along the bat tube 102 to their desired locations, and the fasteners 114 in the band or strap portions 108 of the tines can be re-tightened onto the bat tube 102.

As shown in FIGS. 2 and 3, the bat tube 102 may be pinched in one or more locations to provide the keys 110, such as in two locations generally one hundred eighty degrees away from each other, thereby providing V-shaped features. An internal surface 116 (most easily seen in FIGS. 4 and 5) of a band or strap portion 108 of each of the tines 104 preferably corresponds with a shape of the outer surface 106 of the bat tube 102, thereby providing that the tines 104 are effectively keyed to the bat tube 102 such that the tines 104 cannot readily rotate about the bat tube 102, but can be slid along the length of the bat tube 102, when the bands or strap portions 108 are loosened, to vary the distance between the tines 104. While the tines 104 may be configured to be tightened to the bat tube 102 with a fastener 114 (see FIGS. 4 and 5), preferably the fastener 114 does not engage holes formed in the bat tube 102, but rather just tightens and secures the band or strap portion 108 of the tine 104 around the bat tube 102.

As shown in FIGS. 2 and 3, the bat tube 102 may be installed relative to a pick-up reel such that, for example, one 118 of the keys 110 or pinched areas points down, thereby providing increased bat tube area in the crop gathering direction for improved material handling and favorable crop entry profile. As shown, the other key 120 or pinched area may be provided as pointing up. Alternatively, the bat tube 102 may not be pinched at all, but may instead provide a cross-sectional shape that provides a key or keyway that provides effectively the same function—i.e., that tines 104 are generally prevented from rotating about the bat tube 102, but the location of the tines 104 can be adjusted along the length of the bat tube 102, thereby varying the space between the tines 104.

As shown in FIGS. 2 and 3, the bat tube 102 may be part of a multiple component system, wherein there is provided a plurality of profiles, such as an inner profile 122 and an outer profile 124. As shown, each of the profiles 122, 124 may be provided as being a plurality of bat tube sections, wherein at least some of the bat tube sections 126 which comprise the inner profile 122 are engaged with one or more bearings 128 which are provided as being in accordance with an embodiment of the present invention (to be described in more detail later hereinbelow), and each of the bat tube sections 130 which comprise the outer profile 124 is engaged with at least one bat tube section 126 which comprises the inner profile 122. Preferably, the exterior surface 132 of each of the bat tube sections 126 which comprise the inner profile 122 corresponds to the interior surface 134 of each of the bat tube sections 130 which comprise the outer profile 124, such that the bat tube sections 126 which comprise the inner profile 122 can slide into the bat tube sections 130 which comprise the outer profile 124. The bat tube sections 130 which comprise the outer profile 124 may or may not be fastened to the bat tube sections 126 which comprise the inner profile 122. Regardless, preferably the exterior surface 106 of each of the bat tube sections 130 which comprise the outer profile 124 corresponds to the interior surface 116 (most easily seen in FIGS. 4 and 5) of the band or strap portion 108 of each of the tines 104, such that the band or strap portions 108 of the tines 104 can be slid onto the bat tube sections 130 which comprise the outer profile 124, and can be tightened onto this exterior surface 106.

Regardless of the exact configuration of the bat tube system, preferably its outer surface 106 provides at least one key 110, such as a pair of longitudinal keys such as pinched sections, and at least one corresponding keyway 112 (see also FIGS. 4 and 5) is provided in the band or strap portion 108 of the tines 104. Preferably, the key/keyway engagement provides that the band or strap portions 108 of the tines 104 are generally prevented from rotating about the circumference of the outer surface 106 of the bat tube 102, as well as provides that the tines 104 can be readily re-positioned along the length of the bat tube 102. Additionally, the fact that each of the profiles 122, 124 are provided as being a plurality of bat tube sections rather than a single, long tube, makes the entire design much more serviceable.

As described, bat tube configuration with which a bearing design of the present invention can be used provides a tubular-shaped pick-up reel bat section that has pinched, V-shaped features that are oriented in the vertical position. The V-shaped features are engaged by bat tines, and allows the tines to resist the torsional loads induced by crop gathering. The absence of a set punched or drilled hole pattern for connecting the tines allows for easily variable tine spacing. The vertical profile provides increased bat tube area for crop gathering and favorable crop entry. An inner profile is preferably used with an outer profile to lock bat tube sections together yet allowing them to be easily serviced and allowing for a simplified reel bearing design. An alternative (of which there are many) would be that the V-shaped features would be of alternate form, such as rectangular. Also, the orientation of the V-shaped features may be provided as being slightly off vertical, or even horizontal. Many variations are entirely possible while staying within the scope of the present invention.

Preferably, the bat tube design allows for tine fastening and torsional resistance without drilling or punching holes, which allows for easily variable tine spacings. It also allows for improved crop gathering and crop entry characteristics over a round profile. Typical pick-up reel designs use a long, one-piece bat section, which is difficult to process and requires a wrap-around bearing design. Having an internal and external locking profile, preferably the bat tube design allows for multiple sections without special processing and a simplified bearing design due to the sections being easily serviced.

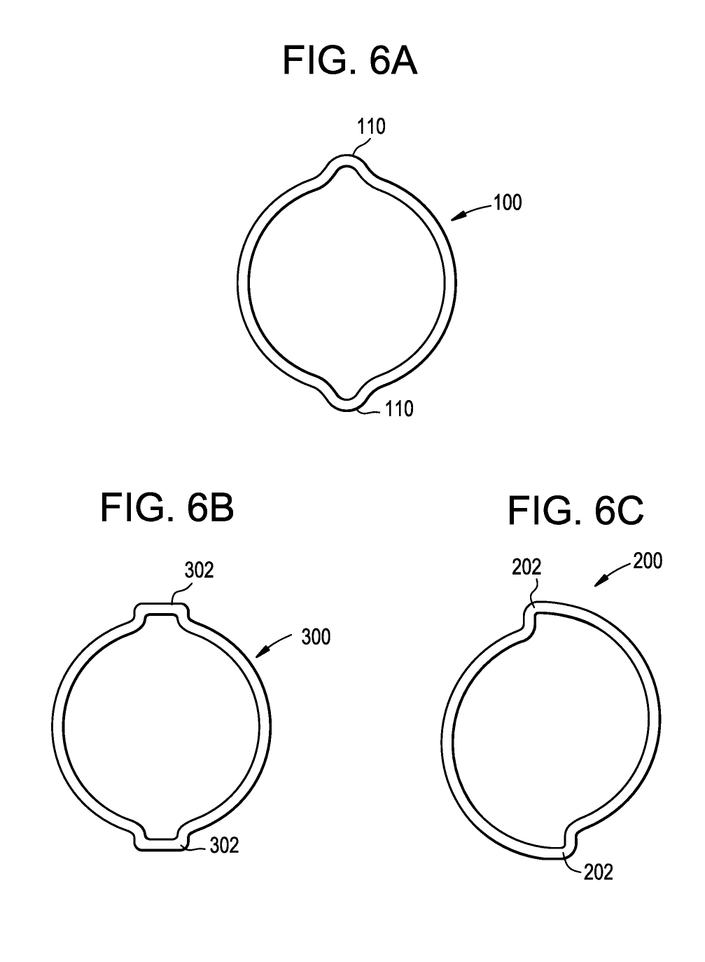

A specific tubular bat shape 100 is illustrated in FIGS. 2 and 3, and has been described in detail. This particular shape 100 is also illustrated in FIG. 6A. FIGS. 6B and 6C also illustrate a couple of alternate shapes 200, 300. Of course, other variations are entirely possible. Regardless of the exact shape or configuration of the bat tube(s), preferably the exterior surface of the bat tube with which the band or strap portions of the tines engage provides at least one key or keyway, such as a pair of longitudinal keys along the length of the bat tube in the form of pinched sections 202, 302, which engages at least one corresponding keyway or key provided in the band or strap portions of the tines which are installed on the bat tube.

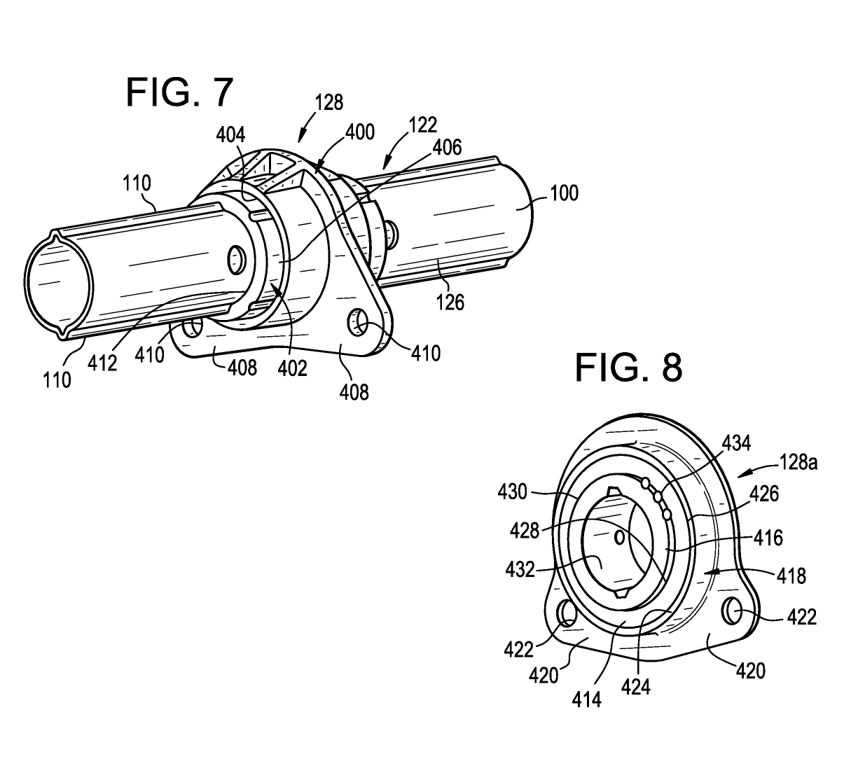

Bearing design embodiments of the present invention will now be described in detail. As discussed above, FIG. 3 illustrates a bearing design 128 which is in accordance with an embodiment of the present invention. That bearing design 128 is also shown in FIG. 7. The bearing design 128 is a non-split bearing. As shown, the bearing design 128 comprises an outer member 400 which directly engages an inner member 402 in the form of a bearing sleeve. Specifically, the outer member 400 has a circular bore 404 which engages a corresponding exterior surface 406 of the inner member 402.

The outer member 400 is configured to connect to an arm 70 of the harvester pick up reel 14, such as is shown in FIG. 3. As shown in FIG. 7, to this end, the outer member 400 preferably has one or more extending flanges 408 that have holes 410 formed therein for receiving fasteners (not specifically shown), for securing the outer member 400 to the arm 40 (i.e., as shown in FIG. 3).

The inner member 402 has an inner bore 412 that is configured to engage the bat tube or bat tube section 100 of the harvester pick up reel 14. The inner member 402 is disposed between the non-circular bat tube 100 and the outer member 400, which is connected to the arm 70 of the harvester pick up reel 14. With regard to materials, both the outer member 400 and inner member 402 are formed of a polymer, a metal such as steel, or any other appropriate material, preferably providing robustness, even and controlled bearing wear, and reduced service requirements.

Many possible exterior surface profiles of bat tubes have been described above and shown in the drawings (i.e., see FIGS. 6A, 6B and 6C, for example). Preferably, the inner bore 412 of the inner member 402 is shaped and configured to mate with one of these bat tube exterior surface profiles such that the inner member 402, once slid onto the bat tube or bat tube section, becomes effectively keyed to the bat tube such that rotation of the inner member 402 around the exterior surface of the bat tube is prevented.

Providing that the overall bearing design is non-split (i.e., that the inner member 402 is a one piece wrap around design which gets slid onto the bat tube or bat tube section) provides that the design is simplified, as well as provides that the inner bore 412, i.e., the bore which engages the bat tube, can be more easily controlled. This reduces service requirements. Preferably, both the outer member 400 and the inner member 402 are formed of materials which provide not only robustness, but also even and controlled bearing wear, and reduced service requirements. Options include, but are not limited to, polymers, metals such as steel, or any other appropriate material.

FIG. 8 illustrates a second embodiment bearing design 128a and is effectively interchangeable with the bearing design 128 previously described, as shown in FIGS. 3 and 7. The bearing design shown in FIG. 8 differs from the bearing design 128 shown in FIGS. 3 and 7 in that the bearing design 128a preferably includes an intermediate member 414 which is disposed between the inner member 416 and the outer member 418. As shown in FIG. 8, the outer member 418 still preferably has one or more extending flanges 420 that have holes 422 formed therein for receiving fasteners (not specifically shown), for securing the outer member 418 to the arm 70 of the pick up reel 14 (see FIG. 3). The outer member 418 preferably has a circular bore 424 which engages an exterior surface 426 of the intermediate member 414. In turn, the intermediate member 414 preferably includes a circular bore 428 which engages an exterior surface 430 of the inner member 416. The inner member 416 has an inner bore 432 which has a shape and profile which corresponds to the bat tube or bat tube section onto which the bearing design slides a slides and effectively keys.

Preferably, there are bearings (identified symbolically in FIG. 8 using circles 434) disposed between the inner member 416 and the intermediate member 414, whereby an inner race is defined on the inner member 416 and an outer race is defined on the intermediate member 414. Preferably, the inner member 416, the intermediate member 414, and the outer member 418 are all formed of metal, such as steel. Of course, other materials could be used.

Both bearing design embodiments (128 and 128a) are configured to slide onto, and effectively lock onto, a bat tube or bat tube section, such as one of the bat tubes or bat tube sections previously described. Regardless of whether the bearing design is provided as having an intermediate member, providing that the bearing is non-split provides that the design is simplified, as well as provides that the inner bore, i.e., the bore which engages the bat tube, can be more easily controlled. This should result in much improved service cycles. In the embodiment (128a) where the bearing is provided as being an interchangeable roller bearing, and there is an intermediate member 414 which is disposed between the outer member 418 and the inner member 416, service may be even be eliminated.

While specific embodiments of the invention have been shown and described, it is envisioned that those skilled in the art may devise various modifications without departing from the spirit and scope of the present invention.

What is claimed is:

1. A multiple component bearing which is configured to connect to an arm of a harvester pick up reel having a non-circular bat tube, said bearing comprising: an outer member which is configured to connect to the arm of the harvester pick up reel; and an inner member which is configured to engage the non-circular bat tube of the harvester pick up reel, wherein the inner member is disposed between the non-circular bat tube and the outer member.

2. The multiple component bearing as recited in claim 1, wherein the outré member comprises a circular bore.

3. The multiple component bearing as recited in claim 1, wherein the outer member directly engages the inner member.

4. The multiple component bearing as recited in claim 1, wherein the bearing is provided as being an interchangeable roller bearing.

5. The multiple component bearing as recited in claim 4, further comprising an intermediate member which is disposed between the outer member and the inner member.

6. The multiple component bearing as recited in claim 1, wherein the bearing is non-split.

7. The multiple component bearing as recited in claim 1, wherein the outer member is formed of at least one of a polymer and a metal, and the inner member is formed of at least one of a polymer and a metal.

8. The multiple component bearing as recited in claim 1, wherein the bearing is provided as being an interchangeable roller bearing, further comprising an intermediate member which is disposed between the outer member and the inner member, and further comprising bearings disposed between the inner member and the intermediate member, wherein an inner race is defined on the inner member and an outer race is defined on the intermediate member.

9. The multiple component bearing as recited in claim 1, wherein the inner member includes a non-circular bore which is configured to engage the non-circular bat tube of the harvester pick up reel, and a surface profile of the non-circular bore effectively corresponds to an outer surface of the non-circular bat tube such that the inner member is keyed to the non-circular bat tube.

10. A pick up reel for a harvester, said pick up reel comprising: at least one arm; at least one non-circular bat tube; a multiple component bearing which is configured to connect to the arm of the harvester pick up reel, said bearing comprising an outer member which is configured to connect to the arm of the harvester pick up reel, said bearing comprising an inner member which is configured to engage the at least one non-circular bat tube of the harvester pick up reel, wherein the inner member is disposed between the non-circular bat tube and the outer member.

11. The pick up reel as recited in claim 10, wherein the inner member of the bearing comprises a non-circular bore which is configured to engage the at least one non-circular bat tube of the harvester pick up reel, wherein the non-circular bore has a surface profile which corresponds to an outer surface of the at least one non-circular bat tube such that the inner member is keyed to the at least one non-circular bat tube.

12. The pick up reel as recited in claim 10, wherein the outer surface of the at least one non-circular bat tube provides at least one longitudinal tine key.

13. The pick up reel as recited in claim 10, wherein the outer surface of the at least one non-circular bat tube provides a plurality of longitudinal tine keys along a length of the non-circular bat tube.

14. The pick up reel as recited in claim 12, wherein the outer surface of the at least one non-circular bat tube has a pinch which provides the at least one longitudinal tine key.

15. The pick up reel as recited in claim 13, wherein the outer surface of the at least one non-circular bat tube has pinches which provide the plurality of longitudinal tine keys.

16. The pick up reel as recited in claim 10, wherein the at least one non-circular bat tube comprises a plurality of tubes in a tube-in-tube configuration.
